(19) United States
(12) Patent Application Publication
(10) Pub. No.: US 2026/0135089 A1
(43) Pub. Date: May 14, 2026

(54) ANODE ACTIVE MATERIAL, ANODE FOR LITHIUM SECONDARY BATTERY, AND LITHIUM SECONDARY BATTERY INCLUDING THE SAME

(71) Applicant: SK On Co., Ltd., Seoul (KR)

(72) Inventors: Seon Jin KIM, Daejeon (KR); Seok Ho SUH, Daejeon (KR); Gi Hyeon MOON, Daejeon (KR); Jong Hyuk LEE, Daejeon (KR)

(21) Appl. No.: 19/369,349

(22) Filed: Oct. 27, 2025

(30) Foreign Application Priority Data
Nov. 12, 2024 (KR) 10-2024-0159951

(51) Int. Cl. H01M 4/36; H01M 4/02; H01M 4/04; H01M 4/587; H01M 4/62; H01M 10/0525

(52) U.S. Cl. CPC H01M 4/366; H01M 4/0471; H01M 4/587; H01M 4/62; H01M 2004/021; H01M 2004/027; H01M 10/0525

(57) ABSTRACT

An anode active material includes a carbon-based active material, and a coating layer disposed on the surface of the carbon-based active material. The coating layer includes a metal hydroxide. The high-temperature stability of an anode active material for a lithium secondary battery may be improved, and a lithium secondary battery with excellent high-temperature operating performance may be provided.

### CROSS-REFERENCE TO RELATED APPLICATION(S)

This patent document claims the priority and benefits of Korean Patent Application No. 10-2024-0159951 filed on Nov. 12, 2024, the disclosure of which is incorporated herein by reference in its entirety.

### TECHNICAL FIELD

The disclosure and implementations disclosed in this patent document generally relate to an anode active material, an anode for a lithium secondary battery, and a lithium secondary battery including the same.

### BACKGROUND

Recently, active research is being conducted on electric vehicles (EVs) as a potential replacement for fossil fuel-powered vehicles, a major cause of air pollution.

Lithium secondary batteries, with their high discharge voltage and output stability, are primarily used as power sources for these EVs.

Therefore, the development of technologies that may improve the performance of lithium secondary batteries is necessary.

### SUMMARY

The present disclosure can be implemented in some embodiments to provide an anode active material for a lithium secondary battery with excellent high-temperature stability.

According to an aspect of the present disclosure, the high-temperature operating performance of a lithium secondary battery may be improved.

In some embodiments of the present disclosure, an anode active material includes a carbon-based active material; and a coating layer disposed on a surface of the carbon-based active material. The coating layer includes a metal hydroxide.

In some embodiments, the anode active material may have a core-shell structure including a core, and a shell disposed on a surface of the core. The core may include a carbon-based active material, and the shell may include a metal hydroxide.

In some embodiments, the metal hydroxide may be represented by the following Chemical Formula 1.

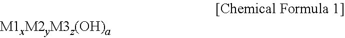

In Chemical Formula 1, M1, M2, and M3 are each at least one metal selected from Al, Ni, Mg, Zn, and Cu, and 0≤x≤1, 0≤y≤1, 0≤z≤1, 0<x+y+z≤1, and 2≤a≤3.

In some embodiments, the coating layer may have a metal element content of 200 ppm to 1,000 ppm as determined by inductively coupled plasma (ICP) analysis.

In some embodiments, a BET specific surface area value of the anode active material may be less than or equal to a BET specific surface area value of the carbon-based active material.

In some embodiments, a BET specific surface area value of the anode active material may be between 0.5 m²/g to 1.5 m²/g.

In some embodiments of the present disclosure, a method of manufacturing an anode active material includes forming a coating layer on a surface of a carbon-based active material. The coating layer includes a metal hydroxide.

In some embodiments, the forming the coating layer may include preparing a powder from a mixture of a carbon-based active material and a solution containing a metal salt; and heat-treating the powder.

In some embodiments, the metal salt may include at least one of a metal nitrate, a metal carbonate, a metal chloride, a metal phosphate, a metal borate, a metal oxide, a metal sulfonate, a metal sulfate, a metal stearate, a metal myristate, a metal acetate, and a metal undecylenic salt.

In some embodiments, a solids content of the mixture may be 75 to 95 wt %.

In some embodiments, the preparing a powder from the mixture may include drying the mixture and obtaining the powder; and classifying the powder.

In some embodiments, the heat-treating may be performed at a temperature of 200° C. to 700° C.

In some embodiments, the heat-treating may be performed for 1 to 3 hours.

In some embodiments of the present disclosure, an anode for a lithium secondary battery includes the anode active material according to any one of the above-described embodiments.

In some embodiments of the present disclosure, a lithium secondary battery includes the anode for a lithium secondary battery according to any one of the above-described embodiments.

### BRIEF DESCRIPTION OF DRAWINGS

Certain aspects, features, and advantages of the present disclosure are illustrated by the following detailed description with reference to the accompanying drawings.

FIG. 1 is a cross-sectional diagram conceptually illustrating the shape of an anode active material according to an embodiment.

FIG. 2 is a diagram illustrating the results of a high-temperature storage capacity retention evaluation for lithium secondary batteries according to Examples and Comparative Example.

FIG. 3 is a diagram illustrating the results of a high-temperature lifespan capacity retention evaluation for lithium secondary batteries according to Examples and Comparative Example.

### DETAILED DESCRIPTION

Features of the present disclosure disclosed in this patent document are described by example embodiments with reference to the accompanying drawings.

Below, the technology disclosed in this specification and its implementation examples are described in detail. However, the embodiments of the technology may be modified in various ways, and the scope is not limited to the implementation examples described below. Furthermore, the technology disclosed in this specification may be applied not only within the configurations of the implementation examples described below, but also in various combinations of all or part of the implementation examples to enable various modifications.

As described above, there is a need for the development of technologies that may improve the performance of lithium secondary batteries. In this regard, high-temperature operation of lithium secondary batteries may lead to performance to various degradation due deteriorations, such as Solid Electrolyte Interphase (SEI) decomposition, electrolyte reduction, and anode cracking. Therefore, to reduce these high-temperature disadvantages, securing high-temperature storage and high-temperature lifespan performance of lithium secondary batteries is required.

According to an embodiment, the high-temperature operating performance of a lithium secondary battery may be improved by applying a surface coating technology to form an artificial Solid Electrolyte Interphase (SEI) on the surface of the anode active material. For example, among carbon-based active materials, natural graphite may be coated with pitch to prevent degradation in rapid charging and high-temperature operating performance due to numerous surface defects.

However, the pitch-formed coating layer is prone to cracking in high-temperature environments, potentially leading to carbon defects, and may thus lead to rapid performance degradation as the operating cycle of the lithium secondary battery progresses.

Meanwhile, among carbon-based active materials, artificial graphite, when used as an anode active material, exhibits high cell resistance and requires high electrode processing complexity, making it difficult to use alone. Therefore, artificial graphite may be mixed with natural graphite. When artificial graphite is mixed with natural graphite and used as the anode active material in a lithium secondary battery, the high-temperature operating performance of the lithium secondary battery may also be inadequate due to the aforementioned problems with natural graphite.

According to an embodiment of the present disclosure, the surface of the carbon-based active material may be coated with a material exhibiting excellent high-temperature stability, thereby improving the high-temperature operating performance of a lithium secondary battery. According to this embodiment, an anode active material exhibiting excellent high-temperature stability, regardless of the type of graphite or the like, may be provided, thereby preventing the aforementioned problems from occurring.

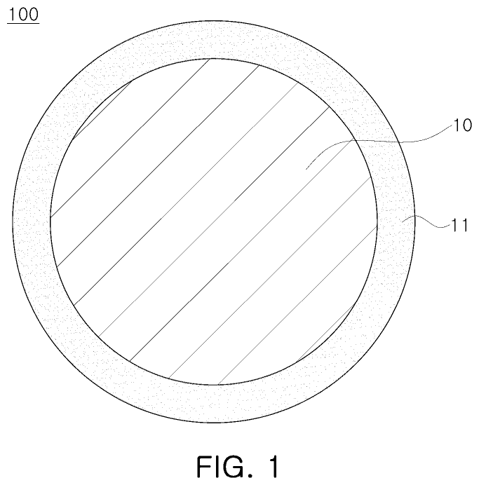

Hereinafter, embodiments of the present disclosure will be described in detail with reference to FIGS. 1 to 3.

FIG. 1 is a cross-sectional view conceptually illustrating the shape of an anode active material according to an embodiment.

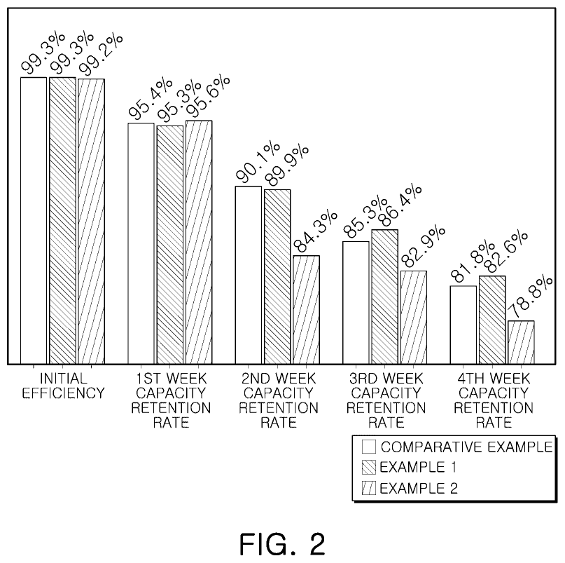

FIG. 2 is a diagram illustrating the results of a high-temperature storage capacity retention evaluation for lithium secondary batteries according to examples and comparative example.

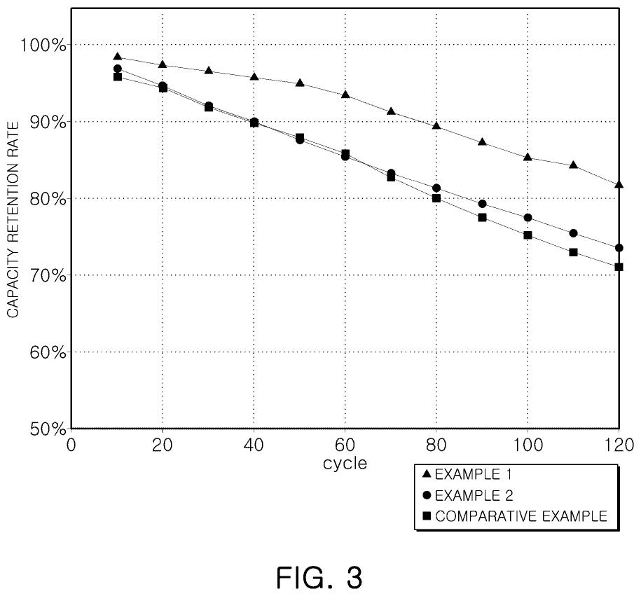

FIG. 3 is a diagram illustrating the results of a high-temperature lifespan capacity retention evaluation for lithium secondary batteries according to examples and comparative example.

### Anode Active Material

An anode active material 100 according to an embodiment includes a carbon-based active material 10, and a coating layer 11 disposed on the surface of the carbon-based active material, and the coating layer includes a metal hydroxide. The anode active material 100 may exhibit excellent high-temperature stability due to the coating layer that includes the metal hydroxide and is formed on the surface of the carbon-based active material.

The carbon-based active material 10 is any carbon-based material capable of storing lithium ions during charging of a lithium secondary battery, and is not particularly limited thereto. For example, the carbon-based active material 10 may include at least one selected from crystalline carbon, amorphous carbon, a carbon composite, and carbon fiber.

The crystalline carbon may be, for example, graphitic carbon such as natural graphite, artificial graphite, graphitized coke, mesocarbon microbeads (MCMB), or graphitized mesophase pitch-based carbon fiber (MPCF).

The amorphous carbon may be, for example, hard carbon, soft carbon, coke, mesocarbon microbeads (MCMB), or mesophase pitch-based carbon fiber (MPCF).

The form of the anode active material 100 is not particularly limited. For example, the anode active material 100 may include a single particle, a secondary particle formed by agglomeration of multiple primary particles, or a combination thereof.

In some embodiments, the anode active material 100 may have a core-shell structure including a core, and a shell disposed on the surface of the core. The core may include a carbon-based active material, and the shell may include a metal hydroxide. In detail, the core may be a particle including the carbon-based active material 10, and the shell may be a coating layer 11.

When the anode active material 100 has the aforementioned core-shell structure, the coating layer 11 acts as a protective layer that uniformly covers the surface of the carbon-based active material 10, thereby delaying material degradation in high-temperature environments. Accordingly, the high-temperature stability of the anode active material 100 may be superior to a structure in which the coating layer 11 is formed in an island shape on the surface of the carbon-based active material 10.

The metal hydroxide included in the coating layer 11 may be formed by heat treatment of a metal salt having excellent high-temperature stability, and the metal hydroxide may be a compound in the form of an intermediate in which the metal salt is not converted into a complete metal ceramic.

In some embodiments, the metal hydroxide may be represented by the following Chemical Formula 1.

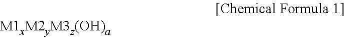

In Chemical Formula 1, M1, M2, and M3 are each at least one metal selected from Al, Ni, Mg, Zn, and Cu, and 0≤x≤1, 0≤y≤1, 0≤z≤1, 0<x+y+z≤1, and 2≤a≤3.

In detail, the metal hydroxide may include aluminum hydroxide (Al(OH)₃) containing aluminum (Al). Aluminum (Al) has a low conversion temperature to hydroxide, and thus, the control thereof is facilitated, and a high conversion rate thereof may be secured. Furthermore, aluminum (Al) has a low reversibility of reaction with lithium after heating, and thus, when the coating layer 11 includes aluminum (Al), stability against side reactions may be improved.

In some embodiments, the coating layer 11 may have a metal element content of 200 ppm to 1,000 ppm according to inductively coupled plasma (ICP) analysis. In detail, the coating layer 11 may have a metal element content of 400 ppm or more, 500 ppm or more, 600 ppm or more, or 650 ppm or more, and may be 800 ppm or less, 700 ppm or less, or 670 ppm or less according to inductively coupled plasma (ICP) analysis. When the metal element content included in the coating layer 11 is within the above-described range, the effect of improving the high-temperature stability of the anode active material 100 by forming the coating layer 11 may be excellent. The unit of the element content value may be ppm on a mass basis. The metal element content may be measured by performing inductively coupled plasma (ICP) analysis using an ICP-MS device (NexION 350s by PerkinElmer) under the following conditions.

$$RF Power = 1200 W$$

$$Plasma flow = 12 L / min$$

$$Nebulizer flow = 0.7 L / min$$

$$Auxiliary flow = 1 L / min$$

In some embodiments, the BET specific surface area value of the anode active material 100 may be lower than or equal to the BET specific surface area value of the carbon-based active material 10. If a coating layer 11 is formed in an island shape on the surface of the carbon-based active material 10, the BET specific surface area may increase compared to the carbon-based active material 10 without the coating layer. On the other hand, if a coating layer 11 that evenly covers the surface of the carbon-based active material 10 is formed, the BET specific surface area may decrease compared to the carbon-based active material 10 without the coating layer. Therefore, if the BET specific surface area value of the anode active material 100 is less than or equal to that of the carbon-based active material 10, the coating layer 11 may be determined to be uniformly formed.

In some embodiments, the BET specific surface area value of the anode active material 100 may be 0.5 m²/g to 1.5 m²/g. In detail, the BET specific surface area value of the anode active material 100 may be 1.0 m²/g or more, or 1.2 m²/g or more, and may be 1.3 m²/g or less.

The BET specific surface area value of the anode active material 100 may be measured using a Macsorb HM model-1208 from NOUNTECH after pretreatment of the anode active material particles by nitrogen (N₂) purging and heat treatment (80° C. for 60 minutes).

### Method of Manufacturing Anode Active Material

According to an embodiment, a method of manufacturing an anode active material 100 includes forming a coating layer 11 on the surface of a carbon-based active material 10, and the coating layer includes a metal hydroxide. The operation of forming the coating layer may include preparing a powder from a mixture of the carbon-based active material and a metal salt-containing solution, and heat-treating the powder. In detail, the method of manufacturing an anode active material 100 in which a coating layer 11 is formed on the surface of the carbon-based active material 10 may be performed using a wet process and a heat treatment process.

The metal salt-containing solution is a solution containing a metal salt and a solvent, and the types of metal and salt contained in the metal salt are not particularly limited. For example, the metal contained in the metal salt may be at least one metal selected from Al, Ni, Mg, Zn, and Cu. In addition, the metal salt may include at least one of a metal nitrate, a metal carbonate, a metal chloride, a metal phosphate, a metal borate, a metal oxide, a metal sulfonate, a metal sulfate, a metal stearate, a metal myristate, a metal acetate, and a metal undecylenic salt.

In some embodiments, the metal salt may include aluminum nitrate (Al(NO₃)₃) that is a nitrate containing aluminum (Al). Compared to other metal salts, the nitrate undergoes an oxidation reaction more readily during heat treatment, and the oxygen (O₂) generated during oxidation contributes to the formation of hydroxide, facilitating the formation of metal hydroxides. Furthermore, using the nitrate may facilitate mass production.

The type of solvent is not particularly limited. For example, the metal salt-containing solution may be an aqueous solution containing water as the solvent.

In some embodiments, the metal salt-containing solution may contain 0.5 to 3.0 wt % of the metal salt. If the metal salt concentration is too low, the coating layer 11 formed on the surface of the carbon-based active material 10 may be insufficient, thereby reducing the high-temperature stability enhancement effect. Additionally, if the concentration of the metal salt is too high, the coating layer 11 formed on the surface of the carbon-based active material 10 may have excessive coverage, which may hinder Solid Electrolyte Interphase (SEI) formation and reduce lithium diffusion.

The mixture may be a solution obtained by adding the carbon-based active material 10 to a metal salt-containing solution and mixing the same. In some embodiments, the solids content of the mixture may be 75 to 95 wt %. In detail, the solids content of the mixture may be 77 wt % or more, or 80 wt % or more, and may be 90 wt % or less, or 85 wt % or less. Adjusting the solids content of the mixture within the above-described range allows for a uniform formation of the coating layer 11 on the surface of the carbon-based active material 10, resulting in excellent coating processability.

In some embodiments, the mixing of the carbon-based active material 10 and the metal salt-containing solution may be performed using a planetary mixer. For example, the planetary mixer may have a rotational speed of 60 to 100 revolutions per minute (RPM).

In some embodiments, the operation of producing a powder from the mixture may include drying the mixture to obtain a powder, and classifying the powder. The powder may be a dry powder produced by drying the mixture (a solution containing wet powder), and the classifying operation may select only powder particles having a particle size (D50) of 10 μm to 20 μm.

The drying of the mixture may be performed, for example, at a temperature of 50° C. to 70° C. for 24 hours or more. The classifying of the powder may be performed, for example, using an ultrasonic classifier.

The powder may be manufactured into an anode active material 100 through heat treatment. In some embodiments, the heat treatment may be performed at a temperature of 200° C. to 700° C. In detail, the heat treatment may be performed at a temperature of 250° C. or higher or 270° C. or higher, or at a temperature of 600° C. or lower, 400° C. or lower, 350° C. or lower, or 330° C. or lower.

If the heat treatment temperature is too low, the coating layer 11 may not substantially be formed. If the heat treatment temperature is too high, the metal salt may be completely converted into a metal ceramic, preventing the formation of a coating layer 11 containing a metal hydroxide that is an intermediate compound.

In some embodiments, the heat treatment may be performed for 1 to 3 hours. If the heat treatment time is too short, the coating layer 11 may not be substantially formed. If the heat treatment time is too long, the metal salt may be completely converted into a metal ceramic, preventing the formation of a coating layer 11 containing a metal hydroxide that is an intermediate compound.

### Anode for Lithium Secondary Battery

According to an embodiment, an anode for a lithium secondary battery includes an anode active material 100 according to any one of the embodiments described above. For example, the anode for a lithium secondary battery may include an anode current collector; and an anode mixture layer on at least one surface of the anode current collector, and the anode mixture layer may include the anode active material 100 according to any one of the embodiments described above.

The components of the anode current collector are not particularly limited. For example, the anode current collector may be a plate or foil composed of at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and alloys thereof. The thickness of the anode current collector is not particularly limited. For example, the thickness of the anode current collector may be 0.1 μm to 50 μm.

The anode mixture layer is a layer disposed on at least one surface of the anode current collector and may include an anode active material. The content of the anode active material included in the anode mixture layer is not particularly limited. For example, the content of the anode active material included in the anode mixture layer may be 70 to 99 wt %.

The anode mixture layer may further include an additional anode active material in addition to the anode active material 100 described above. For example, the additional anode active material may be at least one selected from the group consisting of lithium metal, a lithium alloy, a silicon-containing material, and a tin-containing material.

The elements included in the lithium alloy may be, for example, aluminum, zinc, bismuth, cadmium, antimony, silicon, lead, tin, gallium, or indium.

The silicon-containing material is not particularly limited as long as it contains silicon, and may be an active material capable of alloying with lithium (Li). For example, the silicon-containing material may be at least one selected from the group consisting of silicon (Si), silicon oxide (SiOₓ; 0<x<2), metal-doped silicon oxide (SiOₓ; 0<x<2), carbon-coated silicon oxide (SiOₓ; 0<x<2), silicon-carbon composite (Si—C), and silicon alloy.

In some implementations, the anode mixture layer may further include a binder. The binder is not particularly limited. For example, the binder may be any one of a rubber-based binder such as styrene-butadiene rubber (SBR), fluorine-based rubber, ethylene propylene rubber, butadiene rubber, isoprene rubber, and silane-based rubber; a cellulose-based binder such as carboxymethylcellulose (CMC), hydroxypropylmethylcellulose, methylcellulose, or an alkali metal salt thereof; and combinations thereof.

The content of the binder included in the anode mixture layer is not particularly limited. For example, the content of the binder included in the anode mixture layer may range from 0.1 to 10 wt %.

In some embodiments, the anode mixture layer may further include a conductive material. The type of the conductive material is not particularly limited. For example, the conductive material may be at least one selected from a particulate carbon material and a fibrous carbon material. The particulate carbon material may be carbon black such as Super-P or Super-C, acetylene black, Ketjen black, or the like, and the fibrous carbon material may be carbon fiber, carbon nanotubes (CNT), vapor-grown carbon fiber (VGCF), or the like.

The content of the conductive material included in the anode mixture layer is not particularly limited. For example, the content of the conductive material included in the anode mixture layer may be 0.1 to 10 wt %.

### Lithium Secondary Battery

According to an embodiment, a lithium secondary battery includes an anode for a lithium secondary battery according to any one of the above-described embodiments. The lithium secondary battery may include a unit cell including the anode, cathode, and separator for a lithium secondary battery as described above. The separator may be disposed between the cathode and the anode.

The cathode may include a cathode current collector, and a cathode mixture layer on at least one surface of the cathode current collector.

The components of the cathode current collector are not particularly limited. For example, the cathode current collector may be a plate or foil formed of at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and alloys thereof. The thickness of the cathode current collector is not particularly limited. For example, the thickness of the cathode current collector may range from 0.1 μm to 50 μm.

The cathode mixture layer may include a cathode active material. The cathode active material is not particularly limited and may include a compound capable of reversibly intercalating and deintercalating lithium ions.

For example, the cathode active material may include a lithium-nickel metal oxide. The lithium-nickel metal oxide may further include at least one of cobalt (Co), manganese (Mn), and aluminum (Al).

In some embodiments, the cathode active material or the lithium-nickel metal oxide may include a layered structure or crystal structure represented by the following Chemical Formula 2.

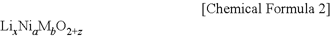

In Chemical Formula 2, 0.9≤x≤1.2, 0.6≤a≤0.99, 0.01≤b≤0.4, and −0.5≤z≤0.1. As described above, M may include Co, Mn, and/or Al.

The chemical structure represented by Chemical Formula 2 represents the bonding relationships within the layered structure or crystal structure of the cathode active material and does not exclude other additional elements. For example, M may include Co and/or Mn, and Co and/or Mn, along with Ni, may serve as the main active element of the cathode active material. The above chemical formula 2 is provided to express the bonding relationship of the main active element and should be understood to encompass the introduction and substitution of additional elements.

In some embodiments, auxiliary elements may be included in addition to the main active element, to enhance the chemical stability of the cathode active material or the layered structure/crystal structure. The auxiliary elements may be incorporated into the layered structure/crystal structure to form bonds, and in this case, should be understood to be within the chemical structure range represented by Chemical Formula 2.

The auxiliary elements may include at least one of for example, Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary elements, such as Al, may also function as auxiliary active elements that contribute to the capacity/output activity of the cathode active material, together with Co or Mn.

For example, the cathode active material or the lithium-nickel metal oxide may include a layered structure or crystal structure represented by the following chemical formula 2-1.

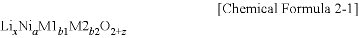

In Chemical Formula 2-1, M1 may include Co, Mn, and/or Al. M2 may include the auxiliary elements described above. In Chemical Formula 2-1, 0.9≤x≤1.2, 0.6≤a≤0.99, 0.01≤b1+b2≤0.4, and −0.5≤z≤0.1.

The cathode active material may further include a coating element or doping element. For example, elements substantially identical to or similar to the auxiliary elements described above may be used as the coating element or doping element. For example, the above-described elements may be used singly or in combination of two or more.

The coating element or doping element may be present on the surface of the lithium-nickel metal oxide particle, or may penetrate through the surface of the lithium-nickel metal composite oxide particle and be incorporated into the bonding structure represented by Chemical Formula 2 or Chemical Formula 2-1.

The cathode active material may include a nickel-cobalt-manganese (NCM)-based lithium oxide. In this case, an NCM-based lithium oxide with an increased nickel content may be used.

The Ni content (for example, the mole fraction of nickel out of the total moles of nickel, cobalt, and manganese) in the NCM-based lithium oxide may be 0.6 or more, 0.7 or more, or 0.8 or more. In some embodiments, the Ni content may be 0.8 to 0.95, 0.82 to 0.95, 0.83 to 0.95, 0.84 to 0.95, 0.85 to 0.95, or 0.88 to 0.95.

In some embodiments, the cathode active material may include a lithium cobalt oxide-based active material, a lithium manganese oxide-based active material, a lithium nickel oxide-based active material, or a lithium iron phosphate (LFP)-based active material (for example, LiFePO₄).

In some embodiments, the cathode active material may include a Mn-rich active material, a Li-rich layered oxide (LLO)/over-lithiated oxide (OLO) active material, or a Co-less active material having a chemical structure or crystal structure represented by Chemical Formula 3.

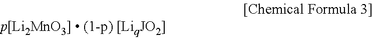

In Chemical Formula 3, 0<p<1, 0.9≤q≤1.2, and J may include at least one element selected from Mn, Ni, Co, Fe, Cr, V, Cu, Zn, Ti, Al, Mg, and B.

The cathode mixture layer may further include a binder. The binder is not particularly limited. For example, the binder may include one or two or more of polyvinylidene fluoride, styrene butadiene rubber (SBR), polytetrafluoroethylene (PTFE), polyvinylidenefluoride vinylidene fluoride/hexafluoropropylene copolymer, polyacrylonitrile, polymethyl methacrylate, and the like.

The cathode mixture layer may further include a conductive material. The conductive material is not particularly limited. Examples of conductive materials may include one type, or two type or more of graphite, such as natural graphite or artificial graphite; carbon-based materials, such as carbon black, acetylene black, Ketjen black, channel black, furnace black, lamp black, thermal black, carbon fiber, and carbon nanotubes (CNT); metal powder particles or fibers, such as copper, nickel, aluminum, and silver; conductive whiskers, such as zinc oxide or potassium titanate; conductive metal oxides, such as titanium oxide; or conductive polymers, such as polyphenylene derivatives.

The separator is not particularly limited. For example, the separator may include a porous polymer film made from a polyolefin polymer, such as an ethylene homopolymer, a propylene homopolymer, an ethylene/butene copolymer, an ethylene/hexene copolymer, or an ethylene/methacrylate copolymer. Furthermore, the separator may include a nonwoven fabric formed of high-melting-point glass fibers, polyethylene terephthalate fibers, or the like.

In some embodiments, the lithium secondary battery may be manufactured by housing the above-described unit cell in a pouch, which is a battery case, and then injecting an electrolyte.

The electrolyte may include an organic solvent and a lithium salt. The organic solvent serves as a medium through which ions involved in the electrochemical reaction of the battery may move, and examples thereof may include carbonate-based, ester-based, ether-based, ketone-based, alcohol-based, or aprotic solvents, used singly or in combination of two or more. When two or more solvents are used in combination, the mixing ratio may be appropriately adjusted depending on the required battery performance.

The lithium salt is a substance that is dissolved in the organic solvent, acts as a source of lithium ions within the battery, enables the basic operation of a lithium secondary battery and promotes the movement of lithium ions between the cathode and anode. Any known material may be used as the lithium salt at a concentration appropriate for the intended purpose. The electrolyte may further include known solvents and known additives, as needed, to improve charge/discharge characteristics, flame retardancy, and other properties.

In some embodiments, the lithium secondary battery may not include a separator between the cathode and anode and may include a solid electrolyte. The solid electrolyte is not particularly limited. For example, the solid electrolyte may be an oxide-based solid electrolyte, a sulfide-based solid electrolyte, or a polymer-based solid electrolyte.

### EXAMPLE

### 1 Anode Active Material

### 1) Preparation of Anode Active Material

### (1) Example 1

The anode active material of Example 1 was prepared by forming a coating layer containing a metal hydroxide on the surface of a carbon-based active material. In detail, a solution containing 80 wt % of solids was prepared by mixing an aluminum nitrate (Al(NO₃)₃) aqueous solution with artificial graphite (a mixture of single particles and Assembled particles), using a planetary mixer for 1 to 2 hours, to prepare a mixture. The concentration of the aluminum nitrate (Al(NO₃)₃) aqueous solution was adjusted to 0.5 wt %, and the rotations per minute (RPM) of the mixer was adjusted to 60.

The mixture was then dried in a convection oven at 50° C. to 70° C. for at least 24 hours and classified using an ultrasonic classifier to produce a powder. The classified powder was placed in a tube furnace and heat treated at 300° C. for 2 hours in a nitrogen atmosphere to produce the final anode active material.

### (2) Example 2

The anode active material of Example 2 was prepared using the same method as Example 1, except that the heat treatment was performed at 600° C.

### (3) Example 3

The anode active material of Example 3 was prepared by forming a coating layer containing a metal hydroxide on the surface of a carbon-based active material. In detail, a solution having a solids content of 87 wt % prepared by mixing an aqueous solution of aluminum nitrate (Al(NO₃)₃) with artificial graphite (mixture of single particles and

Assembled particles) was mixed using a planetary mixer for 1 to 2 hours to produce a mixture. The concentration of the aqueous solution of aluminum nitrate (Al(NO₃)₃) was adjusted to 3 wt %, and the rotational speed of the mixer was set to 100 revolutions per minute (RPM).

The mixture was then dried in a convection oven at 50° C. to 70° C. for 24 hours or more and classified using an ultrasonic classifier to produce powder. The classified powder was then placed in a tube furnace and heat treated at 300° C. for 2 hours in a nitrogen atmosphere to produce the final anode active material.

### (4) Example 4

The anode active material of Example 4 was prepared using the same method as Example 3, except that the heat treatment was performed at 600° C.

### (5) Comparative Example

Artificial graphite (single particle+Assembled particle mixture), a carbon-based active material that did not undergo a separate coating layer formation process, was prepared as the anode active material of the comparative example.

### 2) Anode Active Material Analysis

The anode active materials of the examples and comparative example manufactured as described above were measured for metal element contents through inductively coupled plasma analysis (ICP analysis), BET specific surface areas, and binding energy using X-ray photoelectron spectroscopy (XPS). The results are illustrated in Table 1. The detailed analysis methods are as follows.

### (1) Metal Element Content (ICP Analysis)

Anode active material particles were placed in a polypropylene (PP) tube, and then hydrochloric acid and hydrogen peroxide were added and heated to dissolve. Then, once the sample was clearly dissolved, it was cooled to room temperature (approximately 25° C.) and diluted to prepare the sample for analysis.

Subsequently, ICP analysis was performed on the sample using an ICP-MS device (NexION 350s by PerkinElmer) under the following conditions.

$$RF Power = 1200 W$$

$$Plasma flow = 12 L / min$$

$$Nebulizer flow = 0.7 L / min$$

$$Auxiliary flow = 1 L / min$$

### (2) BET Specific Surface Area Measurement

The anode active material particles were pretreated with nitrogen purging (N₂ purging) and heat treatment (80° C. for 60 minutes). Then, the specific surface area value of the anode active material particles was calculated using NOUNTECH's Macsorb HM model-1208.

### (3) XPS Binding Energy Measurement

The XPS binding energy of the anode active material particles was measured using an ESCALAB 250Xi from Thermo Fisher Scientific under the following conditions.
X-ray: Al k alpha, 1486.68 eV, 650 μm beam size
Analyzer: CAE Mode
Number of scans: 2 (Survey Scan), 20 (Narrow Scan)
Pass energy: 150 eV (Survey Scan), 20 eV (Narrow Scan)

As a result of XPS binding energy measurements, Al and O elements were observed in the anode active materials of Examples 1 to 4 with a coating layer formed, and the Al(OH)₃ phase at 74.8 eV was observed in the Al 2p, but no metal oxide phase was observed at 528 to 530 eV in the O 1s. Accordingly, it was analyzed that the coating layer of the anode active material of Examples 1 to 4 contained aluminum hydroxide (Al(OH)₃) in the form of a metal hydroxide in the group of materials formed of Al and O.

TABLE 1

| Analysis | Comparative | Exam- | Exam- | Exam- | Exam- |
|---|---|---|---|---|---|
| Item | Example | ple 1 | ple 2 | ple 3 | ple 4 |
| Metal Element | 10 or less | 660 | 680 | 710 | 720 |
| Content | | | | | |
| (ppm) | | | | | |
| BET Specific | 1.53 | 1.24 | 1.60 | 1.23 | 1.68 |
| Surface Area | | | | | |
| (m²/g) | | | | | |

| | | |
|---|---|---|
| XPS Binding | X | 74.8 |
| Energy (eV) | | |

Referring to Table 1 above, the anode active material of the comparative example, in which no coating layer was formed, contained a metal element (Al) at a content of 10 ppm or less. However, the anode active materials of Examples 1 to 4, in which a coating layer was formed, contained a relatively high content of Al, ranging from 660 ppm to 720 ppm.

Meanwhile, in Examples 1 and 3, in which the coating layer was formed through a heat treatment process at 300° C., the BET specific surface area of the anode active material was measured to be relatively lower than that of the comparative example. However, in Examples 2 and 4, in which the coating layer was formed through a heat treatment process at 600° C., the BET specific surface area of the anode active material was measured to be relatively higher than that of the comparative example.

It is determined that when the heat treatment temperature is 300° C., a core-shell structure is formed in which the coating layer relatively evenly covers the surface of the carbon-based active material, thereby reducing the specific surface area of the anode active material, but when the heat treatment temperature is relatively high at 600° C., the coating layer is formed in an island shape, thereby increasing the specific surface area of the anode active material.

Furthermore, referring to the XPS analysis results, the anode active materials of Examples 1 to 4, in which the coating layer was formed, all exhibited a peak at 74.8 eV. Considering this, it is determined that the coating layers of Examples 1 to 4 contain the Al(OH)₃ phase, a metal hydroxide.

### 2. Anode Slurry

### 1) Anode Slurry Preparation

An anode slurry containing the anode active materials of Examples and Comparative example prepared as described above was prepared. In detail, the anode slurry was prepared to contain 97 wt % of the anode active material and 3 wt % of the binder (1.2 wt % CMC and 1.8 wt % SBR) based on the solids content.

### 2) Anode Slurry Analysis

The viscosity values measured for the anode slurry are illustrated in Table 2 below. In detail, the viscosity of the anode slurry was measured using a Kinexus Rheometer from NETZSCH, using a plate spindle, at a shear rate of 4.6 s⁻¹ and a temperature of 25° C.

TABLE 2

| Analysis | Comparative | Exam- | Exam- | Exam- | Exam- |
|---|---|---|---|---|---|
| Item | Example | ple 1 | ple 2 | ple 3 | ple 4 |
| Anode Slurry | 10.13 | 20.7 | 19.36 | 21.1 | 19.8 |
| Viscosity | | | | | |
| (pa · s) | | | | | |

Referring to Table 2 above, the viscosity of the anode slurry containing the anode active material of Examples 1 to 4, with a coating layer formed, was measured to be relatively higher than that of the Comparative Example. It is determined that this is due to the increased affinity between the anode active material and the anode binder resulting from the formation of the coating layer.

### 3. Anode and Lithium Secondary Battery

### 1) Fabrication of Anode and Lithium Secondary Battery

To evaluate the performance of the final anode and lithium secondary battery, anodes and lithium secondary batteries were fabricated using the anode slurries of Comparative Example and Examples 1 and 2, respectively, among the anode slurries manufactured as described above.

In detail, the anode slurry was applied to one surface of an 8 μm-thick anode current collector (Cu-Foil), dried at 60° C. for 5 hours, and rolled to an electrode density of 1.5 g/cc to fabricate an anode including an anode mixture layer on one surface of the anode current collector. Subsequently, a separator (polyethylene, 15 μm thick) was disposed between the anode and counter electrode (lithium metal foil), and an electrolyte containing 1 M LiPF₆ dissolved in a mixed solvent of 25 vol % ethylene carbonate (EC)/45 vol % ethyl methyl carbonate (EMC)/30 vol % diethylene carbonate (DEC) was impregnated to manufacture a 2032 type coin-shaped half-cell.

### 2) Performance Evaluation

### 1) Initial Efficiency

The initial efficiency of the coin cell is measured and illustrated in Table 3. The initial efficiency was measured by performing three cycles of charging the coin cell at 25° C. in a CC/CV mode at a rate of 0.1 C within a SOC range of 0-100% and of discharging at 0.1 C with a current<0.05 mA as the CV section termination condition, and measuring the discharge capacity as a percentage compared to the charged electric capacity of the last cycle.

### 2) High-Temperature Storage Capacity Retention

The coin cell was stored at 60° C. and the capacity retention over time was evaluated. The results are illustrated in FIG. 2, and the capacity retention values at week 4 are presented in Table 3 below. The capacity retention was determined by charging the coin cell at a rate of 0.5 C in CC/CV mode within the SOC range of 0-100%, discharging at 0.5 C with a current<0.05 mA at the end of the CV period and repeating this cycle three times at 25° C., and then measuring the discharge capacity based on the last cycle. The discharge capacity at week 4 was measured as a percentage as compared with the initial discharge capacity at week 0.

### 3) High-Temperature Lifespan Capacity Retention

The coin cell was charged and discharged at 45° C. and the capacity retention rate according to the number of cycles was evaluated, and the results are shown in FIG. 3. The capacity retention values at 120 cycles are presented in Table 3 below. At this time, the capacity retention rate was measured as a percentage of the discharge capacity retention rate compared to the initial discharge capacity after repeating the cycle of charging the coin cell at a rate of 0.5 C in CC/CV mode in the SOC 0-100% range and of discharging at 0.5 C with a CV section termination condition of current<0.05 mA, 120 times at 45° C.

TABLE 3

| | | High- | High- |
|---|---|---|---|
| | | Temperature | Temperature |
| | Initial | Storage Capacity | Lifespan Capacity |
| Experimental | Efficiency | Retention (%) | Retention (%) |
| Example | (%) | (Week 4) | (120 cyc.) |
| Comparative | 92 | 81.8 | 70.9 |
| Example | | | |
| Example 1 | 91.5 | 82.6 | 81.8 |
| Example 2 | 99 | 78.8 | 73.4 |

Referring to Table 3 above, it can be confirmed that the initial efficiency of the coin cells in Examples 1 and 2 was equivalent to or higher than that of the Comparative Example, despite surface modification and heat treatment of the carbon-based active material. In detail, Example 1, which underwent heat treatment at 300° C., exhibited 0.8% and 10.9% higher than those of Comparative Example, in 60° C. high-temperature storage and 45° C. high-temperature lifespan capacity retention rates, respectively. Conversely, Example 2, which underwent heat treatment at 600° C., exhibited very high initial efficiency, but relatively poor high-temperature performance.

This is because the coating layer formed by heat treatment at 300° C. acts as a protective layer that evenly covers the surface of the carbon-based active material, thereby delaying material deterioration in a high-temperature environment, whereas the coating layer formed by heat treatment at 600° C. is formed in an island shape, and thus the effect of protecting the surface of the carbon-based active material is relatively low, and the Solid Electrolyte Interphase (SEI) is formed unevenly.

As set forth above, according to an embodiment, the high-temperature stability of an anode active material for a lithium secondary battery may be improved.

According to another embodiment, a lithium secondary battery with excellent high-temperature operating performance may be provided.

Only specific examples of implementations of certain embodiments are described. Variations, improvements and enhancements of the disclosed embodiments and other embodiments may be made based on the disclosure of this patent document.

What is claimed is:

1. An anode active material comprising:
a carbon-based active material; and
a coating layer disposed on a surface of the carbon-based active material,
wherein the coating layer includes a metal hydroxide.

2. The anode active material of claim 1, wherein the anode active material is a core-shell structure including a core, and a shell disposed on a surface of the core,
wherein the core includes a carbon-based active material, and
the shell includes a metal hydroxide.

3. The anode active material of claim 1, wherein the metal hydroxide is represented by chemical formula 1, M1ₓM2_{y}M3_{z}(OH)ₐ, where M1, M2, and M3 are each at least one metal selected from Al, Ni, Mg, Zn, and Cu, and 0≤x≤1, 0≤y≤1, 0≤z≤1, 0<x+y+z≤1, and 2≤a≤3.

4. The anode active material of claim 1, wherein a metal element content of the coating layer, as determined by inductively coupled plasma (ICP) analysis, is 200 ppm to 1,000 ppm.

5. The anode active material of claim 1, wherein a BET specific surface area value of the anode active material is less than or equal to a BET specific surface area value of the carbon-based active material.

6. The anode active material of claim 1, wherein a BET specific surface area value of the anode active material is 0.5 m²/g to 1.5 m²/g.

7. A method of manufacturing an anode active material, comprising:
forming a coating layer on a surface of a carbon-based active material,
wherein the coating layer includes a metal hydroxide.

8. The method of claim 7, wherein the forming the coating layer includes,
preparing a powder from a mixture of the carbon-based active material and a solution containing a metal salt; and
heat-treating the powder.

9. The method of claim 8, wherein the metal salt includes at least one of a metal nitrate, a metal carbonate, a metal chloride, a metal phosphate, a metal borate, a metal oxide, a metal sulfonate, a metal sulfate, a metal stearate, a metal myristate, a metal acetate, and a metal undecylenic salt.

10. The method of claim 8, wherein a solids content of the mixture is 75 to 95 wt %.

11. The method of claim 8, wherein the preparing a powder from the mixture includes,
drying the mixture and obtaining the powder; and
classifying the powder.

12. The method of claim 8, wherein the heat-treating is performed at a temperature of 200° C. to 700° C.

13. The method of claim 8, wherein the heat-treating is performed for 1 to 3 hours.

14. An anode for a lithium secondary battery, comprising the anode active material according to claim 1.
